(19) United States
(12) Patent Application Publication
(10) Pub. No.: US 2026/0073056 A1
(43) Pub. Date: Mar. 12, 2026

(54) VULNERABILITY FUNNEL

(71) Applicant: CAST AI Group, Inc., Miami, FL (US)

(72) Inventor: Markus Gierlinger, Linz (AT)

(21) Appl. No.: 18/990,407

(22) Filed: Dec. 20, 2024

Related U.S. Application Data
(60) Provisional application No. 63/692,196, filed on Sep. 9, 2024.

(51) Int. Cl. G06F 21/57

(52) U.S. Cl. CPC G06F 21/577; G06F 2221/034

(57) ABSTRACT

A vulnerability funneling method that comprises performing, by a processor, multi-stage filtering a target to identify vulnerabilities; filtering, by the processor, non-Known Exploited Vulnerabilities (non-KEVs) from the identified vulnerabilities to identify Known Exploited Vulnerabilities (KEVs) in the identified vulnerabilities; and generating, by the processor, vulnerability information with the identified vulnerabilities and the KEVs classified into filtering stages.

### CROSS-REFERENCE TO RELATED APPLICATIONS

This application claims priority under 35 USC § 119(e) to U.S. Provisional Application No. 63/692,196, filed on Sep. 9, 2024, the contents of which are incorporated herein by reference in their entirety.

### BACKGROUND

### Field

The present disclosure is generally directed to a method and a system for performing vulnerability classification and action recommendations.

### Related Art

There has been a significant increase in the number of newly discovered vulnerabilities in recent years. In 2023 alone, more than 29,000 newly found vulnerabilities were published. This sheer volume is reflected in the findings provided by common commercial scanners. However, the majority of these findings are either false positives, non-actionable, or pose no real threat to the environment.

In the related art, a method for rating/scoring vulnerability severity is disclosed. The method involves rating severity of the vulnerabilities by a Common Vulnerabilities and Exposures (CVE) Numbering Authority (CNA) and assigning a unique identifier, CVE-ID, to each rated vulnerability. Severity of security vulnerabilities is rated with a standardized Common Vulnerability Scoring System (CVSS) with scores ranging from 0 to 10, with 0 indicating no risk and 10 indicating critical severity.

In the related art, a method for estimating the likelihood/probability of a vulnerability being exploited is disclosed. The method provides for a way to prioritize remediation efforts when a vulnerability is likely to be exploited. However, likelihood estimation fails to consider other factors that contribute to a comprehensive cyber security assessment (e.g., context or relevance of an environment, configurations, network reachability, etc.)

It has become abundantly clear in the cyber security industry that the conventional approaches to managing vulnerabilities do not scale and are unable to provide a comprehensive picture of target vulnerabilities. To enable a comprehensive risk-based approach, additional information besides CVSS utilization and likelihood estimations must be used in order to prioritize and process handling of vulnerabilities.

### SUMMARY

In an embodiment, a method for performing vulnerability classification comprises of performing, by a processor, multi-stage filtering of a target to identify vulnerabilities; filtering, by the processor, non-Known Exploited Vulnerabilities (non-KEVs) from the identified vulnerabilities to identify Known Exploited Vulnerabilities (KEVs) in the identified vulnerabilities; and generating, by the processor, vulnerability information with the identified vulnerabilities and the KEVs classified into filtering stages.

The processor may be configured to perform the multi-stage filtering by performing vulnerability scanning to identify a plurality of vulnerabilities; performing first stage filtering on the plurality of vulnerabilities to identify non-triaged vulnerabilities; and performing second stage filtering on the non-triaged vulnerabilities to identify running vulnerabilities associated with workloads that are actively running.

The processor may be configured to perform the multi-stage filtering by further performing third stage filtering on the running vulnerabilities to identify in-use vulnerabilities associated with workloads that are in use; and performing fourth stage filtering on the in-use vulnerabilities to identify Common Vulnerability Scoring System (CVSS) vulnerabilities that exceed a CVSS threshold.

The processor may be configured to perform the multi-stage filtering by further performing fifth stage filtering on the CVSS vulnerabilities to identify in-production vulnerabilities associated with workloads that are in a production environment; and performing sixth stage filtering on the running vulnerabilities to identify publicly exposed vulnerabilities.

The processor may be configured to perform the multi-stage filtering by further performing seventh stage filtering on the publicly exposed vulnerabilities to identify vulnerabilities with an exploitable Proof of Concept (PoC); and performing eighth stage filtering on the vulnerabilities with the exploitable PoC to identify Exploit Prediction Scoring System-based (EPSS-based) vulnerabilities that exceed an EPSS threshold.

The seventh stage filtering may comprise cross-referencing the publicly exposed vulnerabilities against an exploit database.

The filtering stages may comprise (i) the first stage filtering to the eighth stage filtering; and (ii) non-KEV filtering.

The method may further comprise generating, by the processor, a recommendation based on the identified vulnerabilities and/or the KEVs using an Artificial Intelligence (AI) model, wherein the recommendation comprises (i) a recommendation directed to a group of vulnerabilities identified in any of the first stage filtering to the fifth stage filtering; and/or (ii) a targeted recommendation directed to a vulnerability identified in any of the sixth stage filtering to non-KEV filtering.

The processor may be configured to filter the non-KEVs from the identified vulnerabilities by cross-referencing the identified vulnerabilities against a KEV catalog to identify the KEVs, wherein the KEV catalog includes a list of Common Vulnerabilities and Exposures (CVEs) known to have been actively exploited.

The performing multi-stage filtering may be triggered by one or more conditions comprising of (i) receipt of at least one Software Bill of Materials (SBOMs) that forms the target; (ii) receipt of a user request to initiate vulnerability classification.

The vulnerability information may comprise a funnel diagram that visualizes the identified vulnerabilities and the KEVs classified in the filtering stages.

In an embodiment, a system for performing vulnerability classification comprises a target; and a processor in communication with the memory, the processor is configured to: perform multi-stage filtering the target to identify vulnerabilities; filter non-Known Exploited Vulnerabilities (non-KEVs) from the identified vulnerabilities to identify Known Exploited Vulnerabilities (KEVs) in the identified vulnerabilities; and generate vulnerability information with the identified vulnerabilities and the KEVs classified into filtering stages.

The processor may be configured to perform the multi-stage filtering by performing vulnerability scanning to identify a plurality of vulnerabilities; performing first stage filtering on the plurality of vulnerabilities to identify non-triaged vulnerabilities; and performing second stage filtering on the non-triaged vulnerabilities to identify running vulnerabilities associated with workloads that are actively running.

The processor may be configured to perform the multi-stage filtering by further performing third stage filtering on the running vulnerabilities to identify in-use vulnerabilities associated with workloads that are in use; and performing fourth stage filtering on the in-use vulnerabilities to identify Common Vulnerability Scoring System (CVSS) vulnerabilities that exceed a CVSS threshold.

The processor may be configured to perform the multi-stage filtering by further performing fifth stage filtering on the CVSS vulnerabilities to identify in-production vulnerabilities associated with workloads that are in a production environment; and performing sixth stage filtering on the running vulnerabilities to identify publicly exposed vulnerabilities.

The processor may be configured to perform the multi-stage filtering by further performing seventh stage filtering on the publicly exposed vulnerabilities to identify vulnerabilities with an exploitable Proof of Concept (PoC); and performing eighth stage filtering on the vulnerabilities with the exploitable PoC to identify Exploit Prediction Scoring System-based (EPSS-based) vulnerabilities that exceed an EPSS threshold.

The seventh stage filtering may comprise cross-referencing the publicly exposed vulnerabilities against an exploit database.

The filtering stages may comprise (i) the first stage filtering to the eighth stage filtering; and (ii) non-KEV filtering.

The processor may be further configured to generate a recommendation based on the identified vulnerabilities and/or the KEVs using an Artificial Intelligence (AI) model, wherein the recommendation comprises of (i) a recommendation directed to a group of vulnerabilities identified in any of the first stage filtering to the fifth stage filtering; and/or (ii) a targeted recommendation directed to a vulnerability identified in any of the sixth stage filtering to non-KEV filtering.

The processor may be configured to filter the non-KEVs from the identified vulnerabilities by cross-referencing the identified vulnerabilities against a KEV catalog to identify the KEVs, wherein the KEV catalog includes a list of Common Vulnerabilities and Exposures (CVEs) known to have been actively exploited.

The performing the multi-stage filtering may be triggered by one or more conditions comprising of (i) receipt of at least one Software Bill of Materials (SBOMs) that forms the target; (ii) receipt of a user request to initiate vulnerability classification.

The vulnerability information may comprise of a funnel diagram that visualizes the identified vulnerabilities and the KEVs classified in the filtering stages.

In an embodiment, a non-transitory computer readable medium storing computer executable code for performing vulnerability classification, the code when executed by a processor causes the processor to perform multi-stage filtering of a target to identify vulnerabilities; filtering non-Known Exploited Vulnerabilities (non-KEVs) from the identified vulnerabilities to identify Known Exploited Vulnerabilities (KEVs) in the identified vulnerabilities; and generate vulnerability information with the identified vulnerabilities and the KEVs classified into filtering stages.

The processor may be configured to perform the multi-stage filtering by: performing vulnerability scanning to identify a plurality of vulnerabilities; performing first stage filtering on the plurality of vulnerabilities to identify non-triaged vulnerabilities; and performing second stage filtering on the non-triaged vulnerabilities to identify running vulnerabilities associated with workloads that are actively running.

The processor may be configured to perform the multi-stage filtering by further performing third stage filtering on the running vulnerabilities to identify in-use vulnerabilities associated with workloads that are in use; and performing fourth stage filtering on the in-use vulnerabilities to identify Common Vulnerability Scoring System (CVSS) vulnerabilities that exceed a CVSS threshold.

The processor may be configured to perform the multi-stage filtering by further performing fifth stage filtering on the CVSS vulnerabilities to identify in-production vulnerabilities associated with workloads that are in a production environment; and performing sixth stage filtering on the running vulnerabilities to identify publicly exposed vulnerabilities.

The processor may be configured to perform the multi-stage filtering by further performing seventh stage filtering on the publicly exposed vulnerabilities to identify vulnerabilities with an exploitable Proof of Concept (PoC); and performing eighth stage filtering on the vulnerabilities with the exploitable PoC to identify Exploit Prediction Scoring System-based (EPSS-based) vulnerabilities that exceed an EPSS threshold.

The seventh stage filtering may comprise cross-referencing the publicly exposed vulnerabilities against an exploit database.

The filtering stages may comprise (i) the first stage filtering to the eighth stage filtering; and (ii) non-KEV filtering.

The processor may be further configured to generate a recommendation based on the identified vulnerabilities and/or the KEVs using an Artificial Intelligence (AI) model, wherein the recommendation comprises (i) a recommendation directed to a group of vulnerabilities identified in any of the first stage filtering to the fifth stage filtering; and/or (ii) a targeted recommendation directed to a vulnerability identified in any of the sixth stage filtering to non-KEV filtering.

The processor may be configured to filter the non-KEVs from the identified vulnerabilities by cross-referencing the identified vulnerabilities against a KEV catalog to identify the KEVs, wherein the KEV catalog includes a list of Common Vulnerabilities and Exposures (CVEs) known to have been actively exploited.

The performing the multi-stage filtering may be triggered by one or more conditions comprising: (i) receipt of at least one Software Bill of Materials (SBOMs) that forms the target; (ii) receipt of a user request to initiate vulnerability classification.

The vulnerability information may comprise a funnel diagram that visualizes the identified vulnerabilities and the KEVs classified in the filtering stages.

### BRIEF DESCRIPTION OF DRAWINGS

A general architecture that implements the various features of the disclosure will now be described with reference to the drawings. The drawings and the associated descriptions are provided to illustrate example embodiments of the disclosure and not to limit the scope of the disclosure. Throughout the drawings, reference numbers are reused to indicate correspondence between referenced elements.

FIG. 1 illustrates an example system 100 for performing vulnerability classification, in accordance with an example embodiment.

FIG. 2 illustrates an example vulnerability filtering/classification sequence 200 performed by the vulnerability classifier 102, in accordance with an example embodiment.

FIG. 3 illustrates an example process flow 300 for classifying vulnerabilities, in accordance with an example embodiment.

FIG. 4 illustrates an example process flow 400 for performing pre-KEV multi-stage filtering, in accordance with an example embodiment.

FIG. 5 illustrates an example vulnerability funnel 500, in accordance with an example embodiment.

FIG. 6 illustrates an example system 600 for performing vulnerability classification and recommendation generation, in accordance with an example embodiment.

FIG. 7 illustrates an example process flow 700 for performing recommendation generation, in accordance with an example embodiment.

FIG. 8 illustrates an example graphic user interface 800, in accordance with an example embodiment.

FIG. 9 illustrates an example computing environment with an example computer device suitable for use in some example embodiments.

### DETAILED DESCRIPTION

The following detailed description provides details of the figures and example embodiments of the present application. Reference numerals and descriptions of redundant elements between figures are omitted for clarity. Terms used throughout the description are provided as examples and are not intended to be limiting. For example, the use of the term “automatic” may involve fully automatic or semi-automatic embodiments involving user or administrator control over certain aspects of the embodiment, depending on the desired embodiment of one of the ordinary skills in the art practicing embodiments of the present application. Selection can be conducted by a user through a user interface or other input means, or can be implemented through a desired algorithm. Example embodiments as described herein can be utilized either singularly or in combination and the functionality of the example embodiments can be implemented through any means according to the desired embodiments.

Example embodiments provide a new system and method for performing vulnerability classification. Filtering of vulnerabilities can be enriched across a plurality of stages through multi-stage filtering using both public information and contextual information/proprietary information. Implementation of the multi-stage vulnerability filtering process allows for vulnerabilities to be classified according to severity, and for targeted actions and/or recommendations to be generated for the classified vulnerabilities.

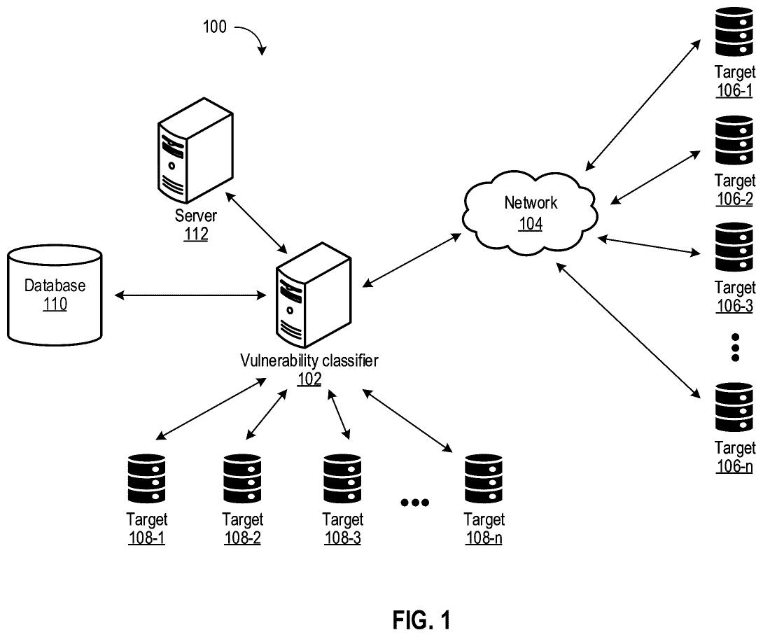

FIG. 1 illustrates an example system 100 for performing vulnerability classification, in accordance with an example embodiment. As illustrated in FIG. 1, the system 100 may include components such as, but not limited to, a vulnerability classifier 102, a network 104, a plurality of targets (e.g., targets 106-1, 106-2, 106-3 . . . 106-n, targets 108-1, 108-2, 108-3 . . . 108-n, etc.), a database 110, etc.

The vulnerability classifier 102 performs the functions of vulnerability scanning and classification on targets. In some embodiment, the vulnerability classifier 102 may directly communicate with the targets (e.g., targets 108-1 to 108-n), or indirectly through the network 104 (e.g. targets 106-1 to 106-n through network 104).

Information used in identifying and classifying vulnerabilities by the vulnerability classifier 102 fall into two broad categories of (i) publicly available information/resources; and (ii) vulnerability contextual information. Publicly available information/resources may include information such as, but not limited to, Exploit Prediction Scoring System (EPSS), Known Exploited Vulnerabilities (KEV) catalog, Proof of Concept (PoC) exploit, third-party information, availability of a fix for a vulnerability, etc.

Exploit Prediction Scoring System (EPSS): The EPSS is a scoring system that estimates the likelihood of a vulnerability being exploited in 30 days and updated on a daily basis. Through utilization of machine learning, the EPSS derives probability scores that range between 0 (indicating the lowest probability of exploitation) and 1 (indicating the highest probability of exploitation, which is equivalent to 100%) for examined vulnerabilities. Use of the EPSS allows remediation efforts to be focused on vulnerabilities that are most imminent.

Known Exploited Vulnerabilities (KEV) catalog: The KEV catalog is a listing of vulnerabilities known to be actively exploited in the wild by malicious actors that is maintained by the Cybersecurity & Infrastructure Security Agency (CISA). Each vulnerability in the KEV catalog is identified by vendor, product, date added, a short description of the vulnerability, available remediation action/fix to the vulnerability, etc. By reviewing and monitoring the KEV catalog, vulnerabilities can be better managed to reduce likelihood of comprise by known vulnerabilities.

Proof of Concept (PoC) exploit: A PoC exploit is a nonharmful attack that is performed to demonstrate security weakness within a target. PoC exploits are commonly shared by the cybersecurity professions to exploit published vulnerabilities, and may be accessed through open-source platforms such as GITHUB, EXPLOIT-DB, etc. Existence of a PoC code for exploit does not automatically imply that the vulnerability is being actively exploited by adversaries. However, the existence of PoC exploits greatly increases the likelihood of vulnerabilities being taken advantage of by attackers.

Third-party information: Third-party information, such as Software Bill of Material (SBOM), also serves as a good source of information for matching vulnerabilities. A SBOM is a detailed record of components that make up/form a software/system, and may include information such as, but not limited to, component identifier/name, version, license information, component dependency, vulnerability information, etc. Other third-party information such as Vulnerability Exploitability eXchange (VEX) may also be utilized in vulnerability management. A VEX is a security advisory statement that allows a software supplier or other parties to assert the status of specific vulnerabilities in a particular product, and can be used to complement or be integrated into an SBOM.

Availability of a fix: The availability of a fix to a vulnerability and the version in which the vulnerability was fixed may be publicly available. A vulnerability can only be patched if a fix is actually available.

In addition to publicly available information/resources, vulnerability contextual information may also be utilized in the risk-based vulnerability funneling process. Vulnerability contextual information is information that helps understand the environment in which a vulnerability exists. This information is also helpful in understanding how the vulnerability may impact a target (e.g., application, software, software package, system, network, etc.). Specifically, vulnerability contextual information may be used to derive insights such as, but not limited to, business relevance, public reachability, runtime reachability, etc.

Business relevance between an environment and its workload: It is common practice to have different environments for different levels of maturity. Commonly, there is at least a development environment used for creating, testing, and debugging software/products without involving any customer data, and a production environment in which the software/product is deployed live for intended users. Codes transition from the development environment to the production environment when they pass/satisfy certain quality checks. In most cases, there are often other stages of environments in between. The environment type can greatly influence the risk of a vulnerability. For instance, a vulnerability in a production environment that is near a database with Personally Identifiable Information (PII) poses a greater threat than the same vulnerability in an isolated workload in the development environment.

Public reachability of a vulnerability: This is also known as network reachability, which indicates whether workload containing the vulnerability is directly exposed to the network/internet (reachable open paths in the environment). To identify the open/vulnerable network paths, configuration of the network and security groups would need to be carefully analyzed to prevent unauthorized access.

Runtime reachability: This tracks the executions at runtime to determine if vulnerable code has been loaded and used. While network reachability looks at the placement of a workload inside the environment, runtime reachability examines the code within the workload. Specifically, only code that has been loaded can be exploited via the network.

The two broad categories of information may be maintained and stored in the database 110 or retrieved as needed from a server (e.g., server 112). Publicly available information such as KEV catalog, EPSS, and PoC exploits may be retrieved from external server(s) and/or database(s). The network 104 may comprise internet, local area network (LAN), wide area network (WAN), telephonic network, cellular network, satellite network, etc., utilizing any transmission protocols such as, but not limited to, Hypertext Transfer Protocol (HTTP), HTTP Secure (HTTPS), Transmission Control Protocol (TCP), File Transfer Protocol (FTP), FTP Secure (FTPS), SSH FTP (SFTP), Trivial File Transfer Protocol (TFTP), etc.

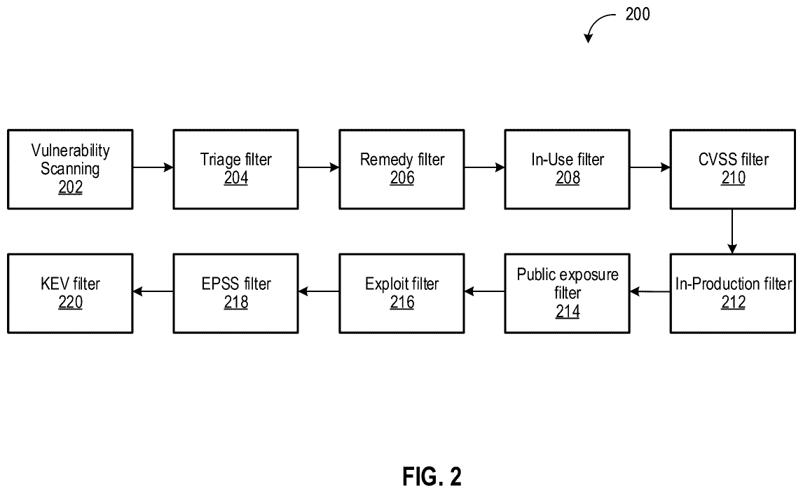

FIG. 2 illustrates an example vulnerability filtering/classification sequence 200 performed by the vulnerability classifier 102, in accordance with an example embodiment. The sequence begins with vulnerability scanning 202 where scanning is performed on a target (e.g., targets 106-1 to 106-n, targets 108-1 to 108-n, etc.) to discover and identify a complete set of vulnerabilities. The vulnerability scanning 202 performs the function of vulnerability identification and does not filter the vulnerabilities.

The triage filter 204 performs the function of filtering out vulnerabilities that have already been triaged to identify non-triaged vulnerabilities. Triaged vulnerabilities are vulnerabilities that have been designated with certain impact status labels in a Vulnerability Exploitability eXchange (VEX). A VEX is a security advisory statement that provides information such as, but not limited to, an examined item/product, one or more vulnerabilities associated with the examined item/product, an associated impact status label(s), etc. In some embodiments, the VEX is generated for a target and stored in the database 110, which may then be retrieved by the vulnerability classifier 102 for review and processing. The impact status labels comprise: (i) non_affected; (ii) affected; (iii) fixed; and (iv) under_investigation. The “non_affected” label indicates that no remedial action is required for the associated vulnerability. The “non_affected” label may also indicate that a vulnerability is false positive. The “affected” label indicates that actions are recommended to address the vulnerability (e.g., a fix is available in a particular version of the product, etc.). The “fixed” label indicates that a fix exists for the particular vulnerability. The “under_investiagtion” label indicates that impact by the vulnerability remains unknown and is in the process of being determined.

In some embodiments, the triaged vulnerabilities may include vulnerabilities having impact status labels of “non_affected” and “affected”. By reviewing the impact status labels of the VEX (which may be stored in the database 110), the vulnerability classifier 102 is able to identify and filter triaged vulnerabilities to identify non-triaged vulnerabilities.

The running filter 206 performs the function of filtering out vulnerabilities that are contained in workloads that are not actively running in any workload environment. By filtering out non-active vulnerabilities, resources can be allocated more efficiently by focusing on vulnerabilities that are active. The in-use filter 208 performs the function of filtering out vulnerable codes that are not in use. Specifically, this involves determining whether a library, a collection of pre-written code, that contains a vulnerable code is loaded at runtime, and filtering out any vulnerable library that has not been loaded.

The Common Vulnerability Scoring System (CVSS) filter 210 performs the function of filtering out vulnerabilities with CVSS scores that are below a certain severity threshold/level. CVSS qualitatively measures the severity level of vulnerabilities by assigning a numerical number that ranges from 0 to 10 to each identified vulnerability. The CVSS score is derived using three primary factors of base (inherent characteristic of the vulnerability), temporal (characteristics of the vulnerability that may change over time), and environment (characteristics of the vulnerability that are relevant to a particular environment).

For vulnerabilities with CVSS scores ranging from 0.1 to 3.9, these are assigned with the severity level of “low”. For vulnerabilities with CVSS scores ranging from 4 to 6.9, these are assigned with the severity level of “medium”. For vulnerabilities with CVSS scores ranging from 7 to 8.9, these are assigned with the severity level of “high”. For vulnerabilities with CVSS scores ranging from 9 to 10, these are assigned with the severity level of “critical”. In some embodiments, the CVSS filter 210 may filter out vulnerabilities with severity levels of “low” and “medium” (e.g., any vulnerability with a CVSS that is less than 7), so that “high” and “critical” vulnerabilities may be prioritized. In some embodiments, filtering may be performed by using a severity score/threshold (e.g., 7, 4, etc.). In other embodiments, filtering may be performed by using a severity score/threshold with a decimal point (e.g., 7.1, 7.5, etc.). In other embodiments, the severity score/threshold may be adjusted based on user preference/input.

The in-production filter 212 performs the function of filtering out vulnerabilities that are contained in workloads that are not actively running in production environment. The public exposure filter 214 performs the function of filtering out internal vulnerabilities that have not been publicly exposed.

The exploit filter 216 performs the function of filtering out vulnerabilities with no available exploit PoCs. Specifically, filtering vulnerabilities with available exploit but no sighting of the exploit being used by malicious actors. PoC exploits are commonly shared by the cybersecurity professions to exploit published vulnerabilities, and may be accessed through open-source platforms such as GITHUB, EXPLOIT-DB, etc.

The Exploit Prediction Scoring System (EPSS) filter 218 performs the function of filtering out vulnerabilities based on EPSS scores. Specifically, an EPSS score/threshold between 0 (indicating the lowest probability of exploitation) and 1(indicating the highest probability of exploitation, which is equivalent to 100%) may be used to filter out vulnerabilities with low probability of exploitation. For instance, the EPSS score/threshold may be set to 0.7 to filter out vulnerabilities with likelihood of exploitation that is less than 70%, so that remediation efforts can be focused on vulnerabilities that are most imminent.

The Known Exploited Vulnerabilities (KEV) filter 220 performs the function of filtering out vulnerabilities that have not been actively exploited in the wild by malicious actors by cross-referencing the KEV catalog. The KEV catalog is a listing of vulnerabilities known to be actively exploited in the wild by malicious actors. A number of organizations and companies such as the Cybersecurity & Infrastructure Security Agency (CISA), VulnCheck™, etc., create and maintain KEV catalogs to help prioritize known exploited vulnerabilities. Each vulnerability in the KEV catalog is identified by vendor, product, date added, a short description of the vulnerability, available remediation action/fix to the vulnerability, etc.

By having the KEV filter 220 as the last stage filter, this allows the various vulnerabilities to be progressively filtered across a number of stages based on publicly available information and context. This allows vulnerabilities and associated metrics to be classified and reviewed in stages, which allows better vulnerability insights to be generated and more targeted actions (e.g., solutions, recommendations, summary, etc.) to be presented at the stage level.

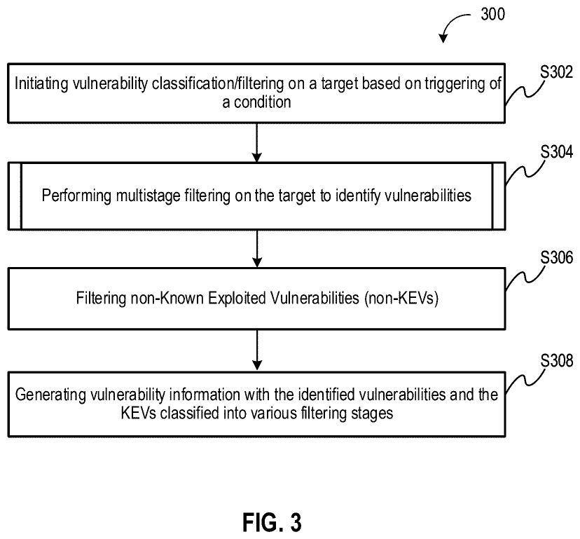

FIG. 3 illustrates an example process flow 300 for classifying vulnerabilities, in accordance with an example embodiment. The process begins at step S302 where a condition or a combination of conditions for performing vulnerability classification/filtering on a target is triggered and causing vulnerability classification/filtering to be initiated. Such conditions may include, but not limited to: (i) receipt of at least one Software Bill of Materials (SBOMs) that makes up/forms a target (e.g., software, system, network, etc.); (ii) receipt of a user request for performing vulnerability classification; or (iii) time trigger that initiates vulnerability classification at preset time intervals (e.g., daily, weekly, etc.).

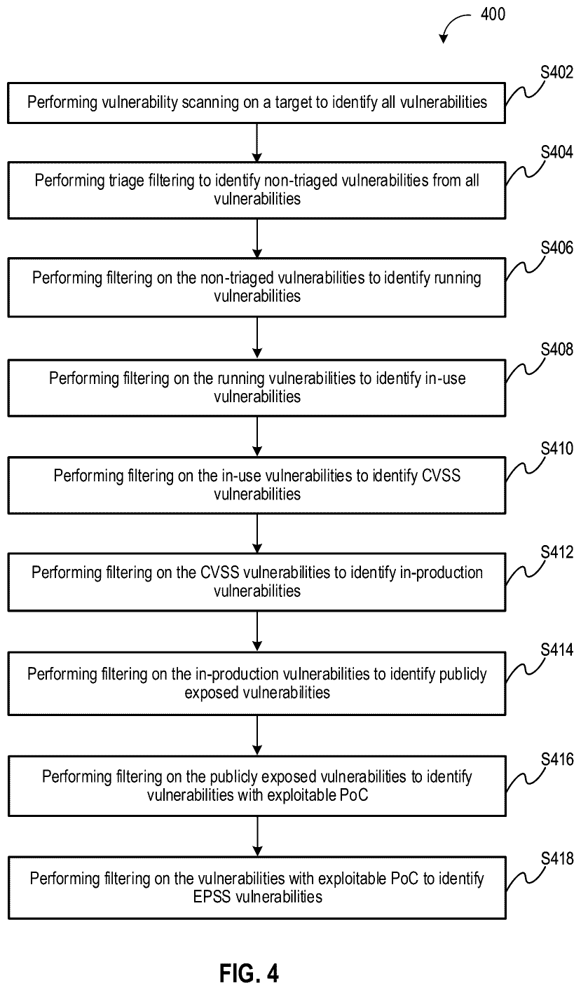

At step S304, multi-stage filtering is performed on the target to identify vulnerabilities. FIG. 4 illustrates an example process flow 400 for performing pre-KEV multi-stage filtering, in accordance with an example embodiment. The sequence begins with step S402 where vulnerability scanning is performed on a target to identify all vulnerabilities. At step S404, filtering of triaged vulnerabilities is performed to identify non-triaged vulnerabilities from all identified vulnerabilities. At step S406, filtering is performed to identify running vulnerabilities from the non-triaged vulnerabilities. Running vulnerabilities are vulnerabilities with workloads that are actively running.

At step S408, filtering is performed to identify in-use vulnerabilities from the running vulnerabilities. Running vulnerabilities are vulnerabilities with workloads that are in use. The process then continues to step S410 where CVSS vulnerabilities are identified from the in-use vulnerabilities. The CVSS vulnerabilities are vulnerabilities that exceed a preset CVSS threshold. In some embodiments, filtering may be performed by using a CVSS score/threshold (e.g., 7, 4, etc.). In other embodiments, filtering may be performed by using a CVSS score/threshold with a decimal point (e.g., 7.1, 7.5, etc.). In other embodiments, the CVSS score/threshold may be adjusted based on user preference/input.

At step S412, filtering is performed to identify in-production vulnerabilities from the CVSS vulnerabilities. The in-production vulnerabilities are vulnerabilities associated with workloads that are in a production environment. At step S414, filtering is performed to identify publicly exposed vulnerabilities from the in-production vulnerabilities. Specifically, internal vulnerabilities that have not been publicly exposed are filtered out during this stage.

At step S416, filtering is performed to identify vulnerabilities with an exploitable PoC from the publicly exposed vulnerabilities. Specifically, vulnerabilities with no available exploit PoCs are filtered out during this stage. Filtering of EPSS vulnerabilities from the exploitable PoC vulnerabilities is then performed at step S418. Specifically, an EPSS score/threshold between 0 and 1 is used to filter out vulnerabilities with low probability of exploitation. For instance, the EPSS score/threshold may be set to 0.7 to filter out vulnerabilities with likelihood of exploitation that is less than 70%, so that remediation efforts can be focused on vulnerabilities that are most imminent.

Returning to FIG. 3, the process then continues to step S306 where non-Known Exploited Vulnerabilities (non-KEVs) are further filtered from the EPSS vulnerabilities to identify Known Exploited Vulnerabilities (KEVs) in the identified vulnerabilities. Specifically, the non-KEVs are filtered from the EPSS vulnerabilities by cross-referencing the EPSS vulnerabilities against a KEV catalog to identify the KEVs. The KEV catalog includes a list of Common Vulnerabilities and Exposures (CVEs) known to have been actively exploited.

At step S308, vulnerability information is generated with the identified vulnerabilities and the KEVs classified into various filtering stages. In some embodiments, the vulnerability information may include information such as, but not limited to, a visual display, a diagram, a chart, summary, etc., to be displayed through a graphic user interface on a user device. Examples of the user device may include, but are not limited to, highly mobile devices (e.g., smartphones, devices in vehicles and other machines, devices carried by humans and animals, and the like), mobile devices (e.g., tablets, notebooks, laptops, personal computers, portable televisions, radios, and the like), and devices not designed for mobility (e.g., desktop computers, other computers, information kiosks, televisions with one or more processors embedded therein and/or coupled thereto, radios, and the like).

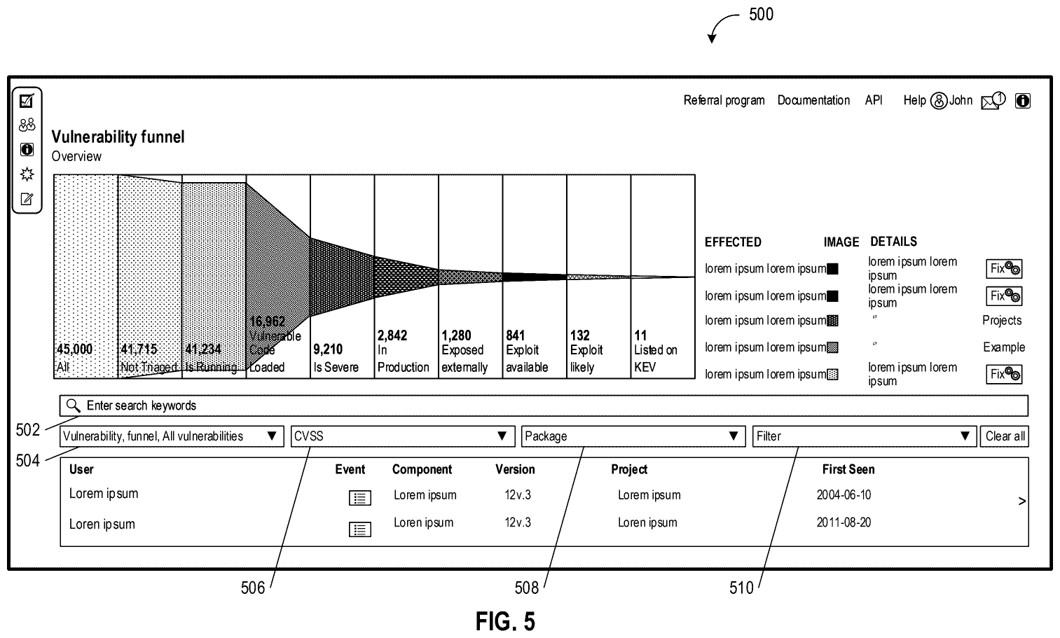

FIG. 5 illustrates an example vulnerability funnel 500, in accordance with an example embodiment. As illustrated in FIG. 5, the vulnerability funnel 500 identifies and classifies the various vulnerabilities based on filtering stages. In some embodiments, each of the filtering stages in the vulnerability funnel 500 may be associated with a distinct color and affixed with a label describing the respective stage (e.g., KEV, EPSS, etc.).

The severity levels of the various stages of the vulnerability funnel 500 increase from left (lowest severity) to right (highest severity). As illustrated in FIG. 5, the “All” stage indicates all findings before any filter is applied. After the triage filter is applied, the identified vulnerabilities reduced from “45,000” to “41,715”. The filtering processes continue until KEV filtering is completed. In some example embodiments, if a filter stage fails to further filter or narrow the vulnerabilities from a preceding stage, then the filter stage may be removed from the vulnerability funnel 500 (e.g., not displayed as part of the diagram, etc.).

In addition to the diagram, information such as, but not limited to, vulnerability details, available fix(es), etc., may also be included as part of the vulnerability funnel 500. A user may enter one or more search terms into a search box 502 to find related vulnerability content. A vulnerability drop-down box 504 allows the user to select a filtering action to be performed on the vulnerabilities (e.g., funnel generation, chart generation, partial review of the vulnerabilities, all vulnerabilities, etc.) A stage selection drop-down box 506 allows the user to select one or more of the filter stages for vulnerability review in association with the key work search.

A target box 508 allows a user to define a desired target type in association with the key word search (e.g., package, software, network, system, etc.) In some example embodiments, filtering stages may be automatically modified based on the selected target type. For example, if “network” or “system” is selected, the software-related filtering stages are removed from multi-stage filtering. An action box 510 allows a user to further select an action to be performed in association with the key word search (e.g., filter, etc.).

### Action Recommendation Engine

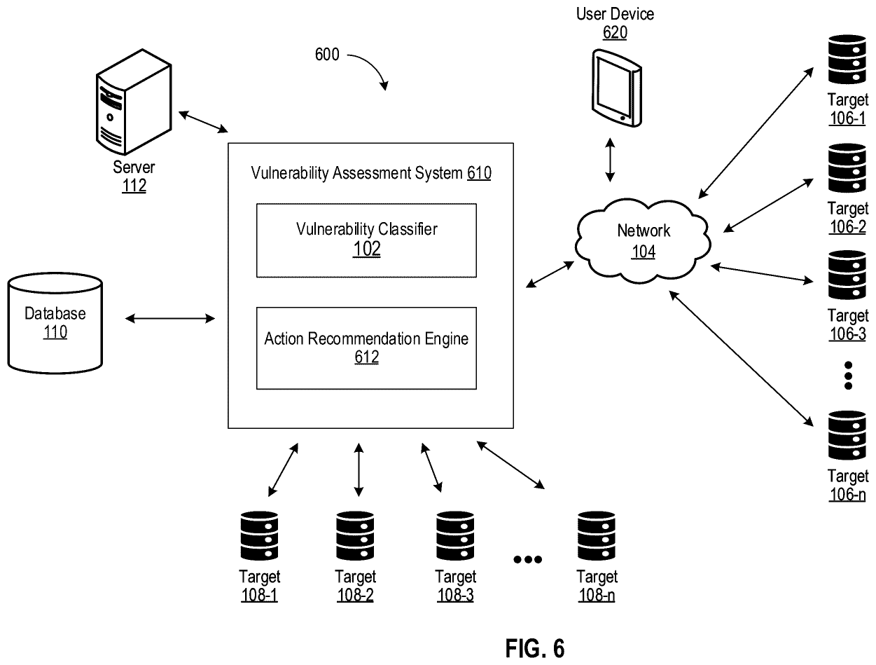

FIG. 6 illustrates an example system 600 for performing vulnerability classification and recommendation generation, in accordance with an example embodiment. As illustrated in FIG. 6, the system 600 may include components such as, but not limited to, a vulnerability assessment system 610, a network 104, a plurality of targets (e.g., targets 106-1 to 106-n, targets 108-1 to 108-n, etc.), a database 110, etc.

The vulnerability assessment system 610 may include components such as, but not limited to, a vulnerability classifier 102 and an action recommendation engine 612. As with FIG. 1, the vulnerability classifier 102 performs the functions of vulnerability scanning and classification on targets. The action recommendation engine 612 performs the function of analyzing the filtered/classified vulnerabilities to generate actions/recommendations. The vulnerability assessment system 610 may communicate directly with the targets (e.g., targets 108-1 to 108-n), or indirectly through the network 104 (e.g. targets 106-1 to 106-n through network 104).

The action recommendation engine 612 receives the filtered vulnerabilities and associated classification information from the vulnerability classifier 102, and generates actions/recommendations directed to the filtered vulnerabilities. In some embodiments, the action recommendation engine 612 utilizes an Artificial Intelligence (AI)/Machine Learning (ML) model to generate the recommendations.

The AI/ML model may be trained using historical data and recommendations generated in the past. The AI/ML model may include, but not limited to, convolutional neural network (CNN), recurrent neural network (RNN), deep RNN (DRNN), Q-learning network (QN), deep Q-learning network (DQN), linear regression, decision trees, K-Nearest Neighbors, etc. RNN may include long short-term memory (LSTM), large language model (LLM), etc.

In some embodiments, derivation and training of the AI/ML model may be performed through the server 112. The trained AI/ML model may then be transmitted from the server 112 and received by the action recommendation engine 612. Communication between the server 112 and the vulnerability assessment system 610 is facilitated through the network 104.

The action recommendation engine 612 may generate two different types of recommendations: (i) a first type of recommendation directed to a single identified vulnerability; and (ii) a second type of recommendation directed to a set of vulnerabilities. The first type of recommendation is intended for vulnerabilities that are high-risk and time-sensitive, and may be customized based on user preferences. In some embodiments, recommendations of the first type (as well as a vulnerability summary) may be automatically generated for each of the vulnerabilities identified in one or more of the public exposure filter stage, the Exploit filter stage, the EPSS filter stage, or the KEV filter stage. The second type of recommendation is intended to address several vulnerabilities that are low-risk at once (e.g., as vulnerability groups). In some embodiments, the second type of recommendation may be used to simultaneously address a number of vulnerabilities that are lower/low in risk level and/or less time-sensitive.

In some embodiments, the action recommendation engine 612 may perform automated vulnerability recovery as part of recommendation generation on a target. For example, on detection of a vulnerability, the action recommendation engine 612 automatically searches and identifies an available/new patch for fixing the detected vulnerability. Once an available/new patch is found, it is automatically deployed to update the target. This may be applied to any of the two different types of recommendations identified above. Performance of automated patching serves to identified vulnerabilities helps prevent security breaches without manual intervention.

If no immediate fix/patch is available as part of the recommendation of the first type, the action recommendation engine 612 then outputs one or more mitigating actions that may be applied to reduce the impact of the vulnerability. Such mitigating actions may include, but not limited to, manual mitigation, resource reconfiguration, etc. In some embodiments, the vulnerability classifier 102 may further generate an attack graph for one or more vulnerabilities, which provides a visual representation of all possible attack paths that an attacker/intruder may utilize to breach a target. The attack graph may then be used as an input to the action recommendation engine 612 in generating resource reconfiguration recommendations to the user/operator of the vulnerability assessment system 610. In some embodiments, the vulnerability assessment system 610 may automatically reconfigure the resources based on the generated recommendations.

For the second type of recommendation, based image recommendations may be made where scanned target is a software/application. This involves analyzation of image hierarchies to determine whether update of a base image is needed. For example, if vulnerabilities are introduced by custom layers that were built/added on top of the based images, lines of code that are associated with/correspond to the custom layers could be identified, and mitigating actions on the code could be generated as part of the recommendation. If the vulnerability is contained in the base image itself, then a recommendation for updating the base image could be made. If the AI/ML model determines that image rebuilding would be able to fix the vulnerability, then a recommend for rebuilding and redeployment of the image could be made.

Vulnerability information (the filtered/classified vulnerabilities and the generate actions/recommendations) as derived by the vulnerability assessment system 610 may be displayed as any combination of a visual display, a diagram, a chart, a textual summary, etc., through a graphic user interface on a user device 620 via network 140. Examples of the user device 620 may include, but are not limited to, highly mobile devices (e.g., smartphones, devices in vehicles and other machines, devices carried by humans and animals, and the like), mobile devices (e.g., tablets, notebooks, laptops, personal computers, portable televisions, radios, and the like), and devices not designed for mobility (e.g., desktop computers, other computers, information kiosks, televisions with one or more processors embedded therein and/or coupled thereto, radios, and the like).

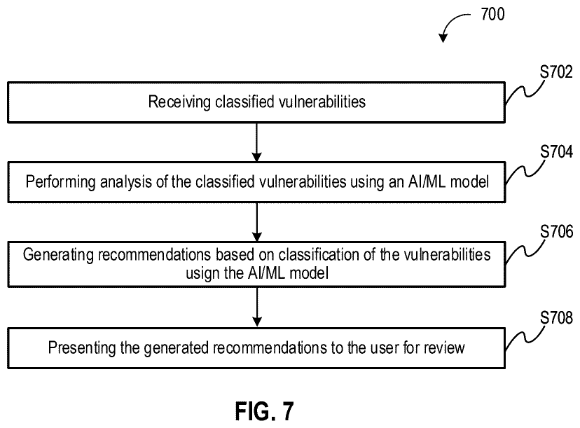

FIG. 7 illustrates an example process flow 700 for performing recommendation generation, in accordance with an example embodiment. The process begins at step S702 where the action recommendation engine 612 receives the classified vulnerabilities from the vulnerability classifier 102. At step S704, the action recommendation engine 612 performs analysis of the vulnerabilities using the AI/ML model. The process then continues to step S706 where the AI/ML model generates recommendations based on classification of the vulnerabilities. The generated recommendations are then presented to the user for review at step S708.

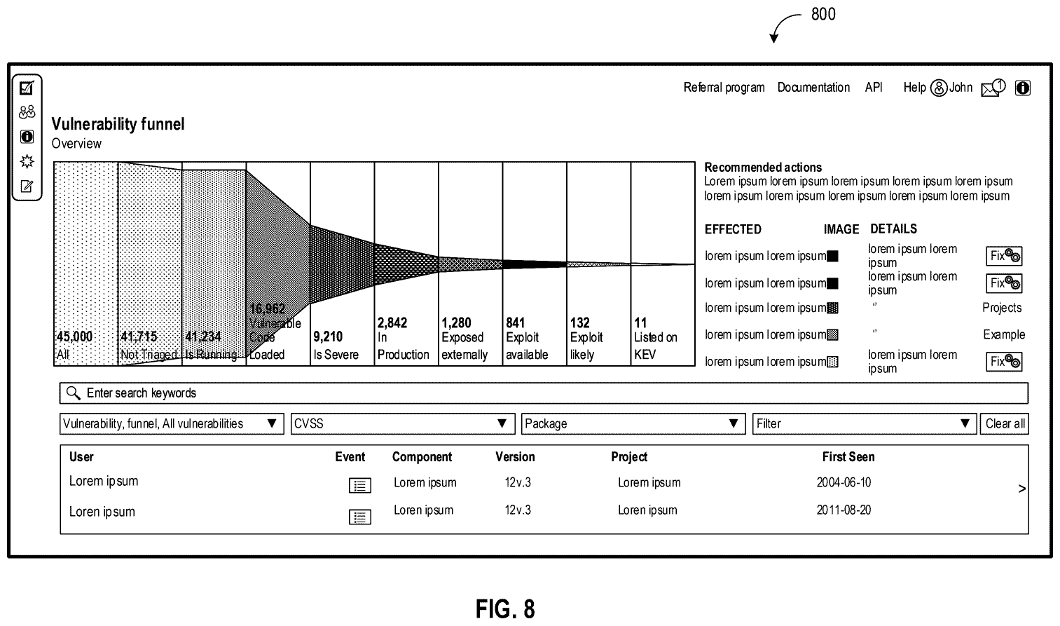

FIG. 8 illustrates an example graphic user interface 800, in accordance with an example embodiment. As with FIG. 5, the vulnerability funnel identifies and classifies the various vulnerabilities based on filtering stages. In some embodiments, each of the filtering stages in the vulnerability funnel 500 may be associated with a distinct color and affixed with a label describing the respective stage (e.g., KEV, EPSS, etc.).

The severity levels of the various stages of the vulnerability funnel 500 increase from left (lowest severity) to right (highest severity). As illustrated in FIG. 5, the “All” stage indicates all findings before any filter is applied. After the triage filter is applied, the identified vulnerabilities reduced from “45,000” to “41,715”. The filtering processes continue until KEV filtering is completed. In some example embodiments, if a filter stage fails to further filter or narrow the vulnerabilities from a preceding stage, then the filter stage may be removed from the vulnerability funnel 500 (e.g., not displayed as part of the diagram, etc.).

As illustrated in FIG. 8, in additional the vulnerability funnel, the graphic user interface 800 further includes a section on recommendations/actions to be taken. In some embodiment, user selection/highlight on one or more areas of the vulnerability funnel would cause a second screen containing detailed recommendations with actionable buttons to be generated.

The foregoing example embodiments may have various benefits and advantages. For example, using identified vulnerabilities as input to an AI/ML model, one or more of automated recovery, mitigating action recommendation, or vulnerability analysis may be performed and outputted by the AI/ML model. Further, performance of automated recovery/patching serves to identified vulnerabilities helps prevent security breaches without the need for manual intervention, which allows for immediate performance of recovery action in real-time.

Although the present disclosure has been described as above with reference to some preferred embodiments, these embodiments should not be constructed as exhaustive or limiting the present disclosure in the form disclosed. Other modifications and variations will be apparent to those of ordinary skill in the art without departing from the scope and spirit of the present disclosure. For example, ordering of one or more filtering stages may be changed, one or more filtering stages may be removed, additional filtering stages may be inserted, one or more filtering stages may be reshuffled based on user preference/input, etc.

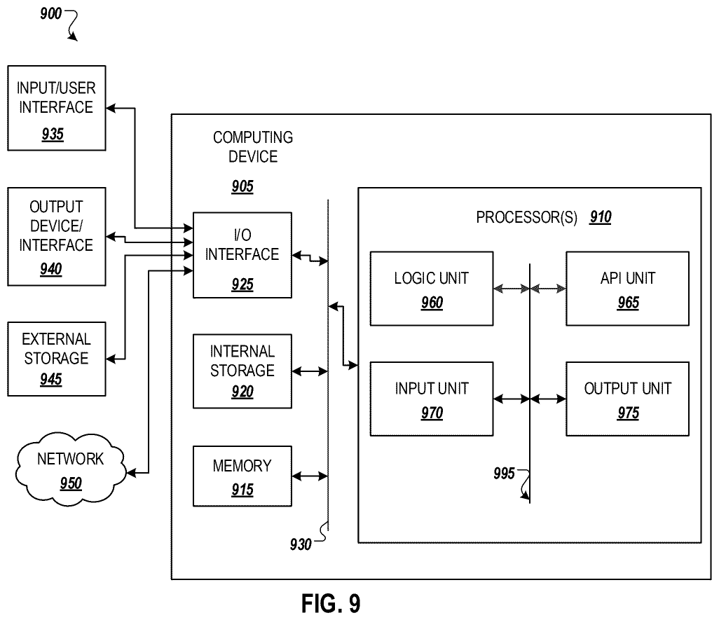

FIG. 9 illustrates an example computing environment with an example computer device suitable for use in some example embodiments. Computer device 905 in computing environment 900 can include one or more processing units, cores, or processors 910, memory 915 (e.g., RAM, ROM, and/or the like), internal storage 920 (e.g., magnetic, optical, solid-state storage, and/or organic), and/or IO interface 925, any of which can be coupled on a communication mechanism or bus 930 for communicating information or embedded in the Computer device 905. IO interface 925 is also configured to receive images from cameras or provide images to projectors or displays, depending on the desired embodiment.

Computer device 905 can be communicatively coupled to input/user interface 935 and output device/interface 940. Either one or both of the input/user interface 935 and output device/interface 940 can be a wired or wireless interface and can be detachable. Input/user interface 935 may include any device, component, sensor, or interface, physical or virtual, that can be used to provide input (e.g., buttons, touch-screen interface, keyboard, a pointing/cursor control, microphone, camera, braille, motion sensor, accelerometer, optical reader, and/or the like). Output device/interface 940 may include a display, television, monitor, printer, speaker, braille, or the like. In some example embodiments, input/user interface 935 and output device/interface 940 can be embedded with or physically coupled to the Computer device 905. In other example of embodiments, other computer devices may function as or provide the functions of input/user interface 935 and output device/interface 50940 for a Computer device 905.

Examples of Computer device 905 may include, but are not limited to, highly mobile devices (e.g., smartphones, devices in vehicles and other machines, devices carried by humans and animals, and the like), mobile devices (e.g., tablets, notebooks, laptops, personal computers, portable televisions, radios, and the like), and devices not designed for mobility (e.g., desktop computers, other computers, information kiosks, televisions with one or more processors embedded therein and/or coupled thereto, radios, and the like).

Computer device 905 can be communicatively coupled (e.g., via IO interface 925) to external storage 945 and network 950 for communicating with any number of networked components, devices, and systems, including one or more computer devices of the same or different configuration. Computer device 905 or any connected computer device can be functioning as, providing services of, or referred to as a server, client, thin server, general machine, special-purpose machine, or another label.

IO interface 925 can include but is not limited to, wired and/or wireless interfaces using any communication or IO protocols or standards (e.g., Ethernet, 802.11x, Universal System Bus, WiMax, modem, a cellular network protocol, and the like) for communicating information to and/or from at least all the connected components, devices, and network in computing environment 900. Network 950 can be any network or combination of networks (e.g., the Internet, local area network, wide area network, a telephonic network, a cellular network, satellite network, and the like).

Computer device 905 can use and/or communicate using computer-usable or computer readable media, including transitory media and non-transitory media. Transitory media include transmission media (e.g., metal cables, fiber optics), signals, carrier waves, and the like. Non-transitory media include magnetic media (e.g., disks and tapes), optical media (e.g., CD ROM, digital video disks, Blu-ray disks), solid-state media (e.g., RAM, ROM, flash memory, solid-state storage), and other non-volatile storage or memory.

Computer device 905 can be used to implement techniques, methods, applications, processes, or computer-executable instructions in some example computing environments. Computer-executable instructions can be retrieved from transitory media and stored on and retrieved from non-transitory media. The executable instructions can originate from one or more of any programming, scripting, and machine languages (e.g., C, C++, C#, Java, Visual Basic, Python, Perl, JavaScript, and others).

Processor(s) 910 can execute under any operating system (OS) (not shown), in a native or virtual environment. One or more applications can be deployed that include logic unit 960, application programming interface (API) unit 965, input unit 970, output unit 975, and inter-unit communication mechanism 995 for the different units to communicate with each other, with the OS, and with other applications (not shown). The described units and elements can be varied in design, function, configuration, or embodiment and are not limited to the descriptions provided. Processor(s) 910 can be in the form of hardware processors such as central processing units (CPUs) or in a combination of hardware and software units.

In some example embodiments, when information or an execution instruction is received by API unit 965, it may be communicated to one or more other units (e.g., logic unit 960, input unit 970, output unit 975). In some instances, logic unit 960 may be configured to control the information flow among the units and direct the services provided by API unit 965, the input unit 970, the output unit 975, in some example embodiments described above. For example, the flow of one or more processes or embodiments may be controlled by logic unit 960 alone or in conjunction with API unit 965. The input unit 970 may be configured to obtain input for the calculations described in the example embodiments, and the output unit 975 may be configured to provide an output based on the calculations described in example embodiments.

Processor(s) 910 can be configured to perform multi-stage filtering a target to identify vulnerabilities as illustrated in FIGS. 2-5. The processor(s) 910 may also be configured to filtering non-Known Exploited Vulnerabilities (non-KEVs) from the identified vulnerabilities to identify Known Exploited Vulnerabilities (KEVs) in the identified vulnerabilities as illustrated in FIGS. 2-5. The processor(s) 910 may also be configured to generate vulnerability information with the identified vulnerabilities and the KEVs classified into filtering stages as illustrated in FIGS. 2-5.

The processor(s) 910 may also be configured to perform vulnerability scanning to identify a plurality of vulnerabilities as illustrated in FIGS. 2-5. The processor(s) 910 may also be configured to perform first stage filtering on the plurality of vulnerabilities to identify non-triaged vulnerabilities as illustrated in FIGS. 2-5. The processor(s) 910 may also be configured to perform second stage filtering on the non-triaged vulnerabilities to identify running vulnerabilities associated with workloads that are actively running as illustrated in FIGS. 2-5. The processor(s) 910 may also be configured to perform third stage filtering on the running vulnerabilities to identify in-use vulnerabilities associated with workloads that are in use as illustrated in FIGS. 2-5. The processor(s) 910 may also be configured to perform fourth stage filtering on the in-use vulnerabilities to identify Common Vulnerability Scoring System (CVSS) vulnerabilities that exceed a CVSS threshold as illustrated in FIGS. 2-5. The processor(s) 910 may also be configured to perform fifth stage filtering on the CVSS vulnerabilities to identify in-production vulnerabilities associated with workloads that are in a production environment as illustrated in FIGS. 2-5. The processor(s) 910 may also be configured to perform sixth stage filtering on the running vulnerabilities to identify publicly exposed vulnerabilities as illustrated in FIGS. 2-5. The processor(s) 910 may also be configured to perform seventh stage filtering on the publicly exposed vulnerabilities to identify vulnerabilities with an exploitable Proof of Concept (PoC) as illustrated in FIGS. 2-5. The processor(s) 910 may also be configured to perform eighth stage filtering on the vulnerabilities with the exploitable PoC to identify Exploit Prediction Scoring System-based (EPSS-based) vulnerabilities that exceed an EPSS threshold as illustrated in FIGS. 2-5.

The processor(s) 910 may also be configured to generate a recommendation based on the identified vulnerabilities and/or the KEVs using an Artificial Intelligence (AI) model, wherein the recommendation comprises (i) a recommendation directed to a group of vulnerabilities identified in any of the first stage filtering to the fifth stage filtering; and/or (ii) a targeted recommendation directed to a vulnerability identified in any of the sixth stage filtering to non-KEV filtering as illustrated in FIGS. 6-8.

Some portions of the detailed description are presented in terms of algorithms and symbolic representations of operations within a computer. These algorithmic descriptions and symbolic representations are the means used by those skilled in the data processing arts to convey the essence of their innovations to others skilled in the art. An algorithm is a series of defined steps leading to a desired end state or result. In example embodiments, the steps carried out require physical manipulations of tangible quantities for achieving a tangible result.

Unless specifically stated otherwise, as apparent from the discussion, it is appreciated that throughout the description, discussions utilizing terms such as “processing,” “computing,” “calculating,” “determining,” “displaying,” or the like, can include the actions and processes of a computer system or other information processing device that manipulates and transforms data represented as physical (electronic) quantities within the computer system's registers and memories into other data similarly represented as physical quantities within the computer system's memories or registers or other information storage, transmission or display devices.

Example embodiments may also relate to an apparatus for performing the operations herein. This apparatus may be specially constructed for the required purposes, or it may include one or more general-purpose computers selectively activated or reconfigured by one or more computer programs. Such computer programs may be stored in a computer readable medium, such as a computer readable storage medium or a computer readable signal medium. A computer readable storage medium may involve tangible mediums such as, but not limited to optical disks, magnetic disks, read-only memories, random access memories, solid-state devices, and drives, or any other types of tangible or non-transitory media suitable for storing electronic information. A computer readable signal medium may include mediums such as carrier waves. The algorithms and displays presented herein are not inherently related to any particular computer or other apparatus. Computer programs can involve pure software embodiments that involve instructions that perform the operations of the desired embodiment.

Various general-purpose systems may be used with programs and modules in accordance with the examples herein, or it may prove convenient to construct a more specialized apparatus to perform desired method steps. In addition, the example embodiments are not described with reference to any particular programming language. It will be appreciated that a variety of programming languages may be used to implement the teachings of the example embodiments as described herein. The instructions of the programming language(s) may be executed by one or more processing devices, e.g., central processing units (CPUs), processors, or controllers.

As is known in the art, the operations described above can be performed by hardware, software, or some combination of software and hardware. Various aspects of the example embodiments may be implemented using circuits and logic devices (hardware), while other aspects may be implemented using instructions stored on a machine-readable medium (software), which if executed by a processor, would cause the processor to perform a method to carry out embodiments of the present application. Further, some example embodiments of the present application may be performed solely in hardware, whereas other example embodiments may be performed solely in software. Moreover, the various functions described can be performed in a single unit, or can be spread across a number of components in any number of ways. When performed by software, the methods may be executed by a processor, such as a general-purpose computer, based on instructions stored on a computer readable medium. If desired, the instructions can be stored on the medium in a compressed and/or encrypted format.

Moreover, other embodiments of the present application will be apparent to those skilled in the art from consideration of the specification and practice of the teachings of the present application. Various aspects and/or components of the described example embodiments may be used singly or in any combination. It is intended that the specification and example embodiments be considered as examples only, with the true scope and spirit of the present application being indicated by the following claims.

What is claimed is:

1. A vulnerability classification method, the method comprising:
performing, by a processor, multi-stage filtering a target to identify vulnerabilities;
filtering, by the processor, non-Known Exploited Vulnerabilities (non-KEVs) from the identified vulnerabilities to identify Known Exploited Vulnerabilities (KEVs) in the identified vulnerabilities; and
generating, by the processor, vulnerability information with the identified vulnerabilities and the KEVs classified into filtering stages.

2. The method of claim 1, wherein the processor is configured to perform the multi-stage filtering by:
performing vulnerability scanning to identify a plurality of vulnerabilities;
performing first stage filtering on the plurality of vulnerabilities to identify non-triaged vulnerabilities; and
performing second stage filtering on the non-triaged vulnerabilities to identify running vulnerabilities associated with workloads that are actively running.

3. The method of claim 2, wherein the processor is configured to perform the multi-stage filtering by further performing:
performing third stage filtering on the running vulnerabilities to identify in-use vulnerabilities associated with workloads that are in use; and
performing fourth stage filtering on the in-use vulnerabilities to identify Common Vulnerability Scoring System (CVSS) vulnerabilities that exceed a CVSS threshold.

4. The method of claim 3, wherein the processor is configured to perform the multi-stage filtering by further performing:
performing fifth stage filtering on the CVSS vulnerabilities to identify in-production vulnerabilities associated with workloads that are in a production environment; and
performing sixth stage filtering on the running vulnerabilities to identify publicly exposed vulnerabilities.

5. The method of claim 4, wherein the processor is configured to perform the multi-stage filtering by further performing:
performing seventh stage filtering on the publicly exposed vulnerabilities to identify vulnerabilities with an exploitable Proof of Concept (PoC); and
performing eighth stage filtering on the vulnerabilities with the exploitable PoC to identify Exploit Prediction Scoring System-based (EPSS-based) vulnerabilities that exceed an EPSS threshold.

6. The method of claim 5, wherein the seventh stage filtering comprises cross-referencing the publicly exposed vulnerabilities against an exploit database.

7. The method of claim 6, wherein the filtering stages comprise (i) the first stage filtering to the eighth stage filtering; and (ii) non-KEV filtering.

8. The method of claim 6, further comprising:
generating, by the processor, a recommendation based on the identified vulnerabilities and/or the KEVs using an Artificial Intelligence (AI) model,
wherein the recommendation comprises (i) a recommendation directed to a group of vulnerabilities identified in any of the first stage filtering to the fifth stage filtering; and/or (ii) a targeted recommendation directed to a vulnerability identified in any of the sixth stage filtering to non-KEV filtering.

9. The method of claim 1, wherein the processor is configured to filter the non-KEVs from the identified vulnerabilities by cross-referencing the identified vulnerabilities against a KEV catalog to identify the KEVs, wherein the KEV catalog includes a list of Common Vulnerabilities and Exposures (CVEs) known to have been actively exploited.

10. The method of claim 1, wherein the performing the multi-stage filtering is triggered by one or more conditions comprising: (i) receipt of at least one Software Bill of Materials (SBOMs) that forms the target; or (ii) receipt of a user request to initiate vulnerability classification.

11. The method of claim 1, wherein the vulnerability information comprises a funnel diagram that visualizes the identified vulnerabilities and the KEVs classified in the filtering stages.

12. A non-transitory computer readable medium, storing instructions for performing vulnerability classification to be executed by a processor, the instructions comprising:
performing multi-stage filtering a target to identify vulnerabilities;
filtering non-Known Exploited Vulnerabilities (non-KEVs) from the identified vulnerabilities to identify Known Exploited Vulnerabilities (KEVs) in the identified vulnerabilities; and
generating vulnerability information with the identified vulnerabilities and the KEVs classified into filtering stages.

13. The non-transitory computer readable medium of claim 12, wherein the performing the multi-stage filtering the target to identify the vulnerabilities comprises:
performing vulnerability scanning to identify a plurality of vulnerabilities;
performing first stage filtering on the plurality of vulnerabilities to identify non-triaged vulnerabilities; and
performing second stage filtering on the non-triaged vulnerabilities to identify running vulnerabilities associated with workloads that are actively running.

14. The non-transitory computer readable medium of claim 13, wherein the performing the multi-stage filtering the target to identify the vulnerabilities further comprises:
performing third stage filtering on the running vulnerabilities to identify in-use vulnerabilities associated with workloads that are in use; and
performing fourth stage filtering on the in-use vulnerabilities to identify Common Vulnerability Scoring System (CVSS) vulnerabilities that exceed a CVSS threshold.

15. The non-transitory computer readable medium of claim 14, wherein the performing the multi-stage filtering the target to identify the vulnerabilities further comprises:
performing fifth stage filtering on the CVSS vulnerabilities to identify in-production vulnerabilities associated with workloads that are in a production environment; and
performing sixth stage filtering on the running vulnerabilities to identify publicly exposed vulnerabilities.

16. The non-transitory computer readable medium of claim 15, wherein the performing the multi-stage filtering the target to identify the vulnerabilities further comprises:
performing seventh stage filtering on the publicly exposed vulnerabilities to identify vulnerabilities with an exploitable Proof of Concept (PoC); and
performing eighth stage filtering on the vulnerabilities with the exploitable PoC to identify Exploit Prediction Scoring System-based (EPSS-based) vulnerabilities that exceed an EPSS threshold.

17. The non-transitory computer readable medium of claim 16, wherein the seventh stage filtering comprises cross-referencing the publicly exposed vulnerabilities against an exploit database.

18. The non-transitory computer readable medium of claim 17, wherein the filtering stages comprise (i) the first stage filtering to the eighth stage filtering; and (ii) non-KEV filtering.

19. The non-transitory computer readable medium of claim 17, further comprising:
generating, by the processor, a recommendation based on the identified vulnerabilities and/or the KEVs using an Artificial Intelligence (AI) model,
wherein the recommendation comprises (i) a recommendation directed to a group of vulnerabilities identified in any of the first stage filtering to the fifth stage filtering; and/or (ii) a targeted recommendation directed to a vulnerability identified in any of the sixth stage filtering to non-KEV filtering.

20. The non-transitory computer readable medium of claim 12, wherein the processor is configured to filter the non-KEVs from the identified vulnerabilities by cross-referencing the identified vulnerabilities against a KEV catalog to identify the KEVs, wherein the KEV catalog includes a list of Common Vulnerabilities and Exposures (CVEs) known to have been actively exploited.
